(19) United States
(12) Patent Application Publication
(10) Pub. No.: US 2005/0209936 A1
(43) Pub. Date: Sep. 22, 2005

(54) Textile finishing temperature monitoring systems and method

(76) Inventor: Stephen Lee Guy, Nashville, NC (US)

Correspondence Address: NOVEON IP HOLDINGS CORP., 9911 BRECKSVILLE ROAD, CLEVELAND, OH, 44141-3247, US

(21) Appl. No.: 11/058,390

(22) Filed: Feb. 15, 2005

Related U.S. Application Data
(60) Provisional application No. 60/545,462, filed on Feb. 17, 2004.

(51) Int. Cl. G06F 17/60

(52) U.S. Cl. 705/28

(57) ABSTRACT

A system for monitoring temperatures in textile finishing operations includes a temperature sensing device (10). The device includes a module (40) therein which is operative to capture data corresponding to temperature sensed at a thermocouple (48) as the device moves through a tenter frame (54) in engagement with a web (22) of textile material. The data captured by the device is transmitted to a computer (62) and visually perceivable outputs corresponding to temperatures recorded can be output through a display (66) and/or a printer (68). Data may also be output real time and may be used to adjust operating conditions in the tenter frame through communication between the computer and a controller (60) which controls temperature and/or air flow within the tenter frame.

### CROSS REFERENCE TO RELATED APPLICATION

This application claims priority from U.S. Provisional Application Ser. No. 60/545,462 filed on Feb. 17, 2004.

### TECHNICAL FIELD

This invention relates to textile manufacturing. Specifically, this invention relates to systems and methods for monitoring and controlling temperatures during textile finishing operations.

### BACKGROUND

In the manufacture of textile materials, the finishing operation is often the final step. The finishing operation typically imparts the aesthetic and physical properties to the material that are desired for the particular use. These properties are achieved through a combination of chemical and mechanical processes. These processes are often designed to maintain shrinkage control, achieve stain resistance, provide water repellency, provide appropriate stiffness and maintain uniform textile consistency.

Finishing operations typically involve saturating the fabric material in a solution of chemicals. Generally, these chemicals are water-based materials. These finishing chemicals may be applied in various ways including for example, immersion of the fabric in chemical baths or through the application of foam to the fabric. Once the fabric has been treated with finishing chemicals, it is then necessary to appropriately treat the material to drive off excess moisture and to cure the materials. This is often done by passing the material through preliminary moisture removing operations and then through a curing and drying device. The curing and drying device provides heating and appropriate air flow to drive off excess moisture and to cure materials remaining on the fabric. In many textile manufacturing operations, the finishing operation includes passing a moving web of textile material through a tenter frame which mechanically acts on the material to prevent shrinkage and which also includes appropriate heating and air flow devices to achieve the desired textile properties.

Maintenance of proper temperature control within finishing operations is critical to achieving consistent, suitable quality textile materials. Failure to achieve suitable temperatures in all areas of the material can result in material that must be scrapped. Exposing material to excessive temperatures can likewise cause damage. Because in finishing operations much of the water must be driven out of the material before the fabric temperature will rise above the vaporization temperature, it can be difficult to apply the appropriate amount of heating for the appropriate period of time to achieve drying without damaging the finished product. In addition, because textiles are often produced in continuous webs that are relatively wide, consistent curing and drying temperatures across the entire transverse width of the moving web are sometimes difficult to maintain. As can be appreciated, textile finishing operations generally run at significant manufacturing rates, and if a problem in the finishing process occurs considerable off spec, poor performing scrap material may be produced before the problem can be corrected.

Conventional temperature measurement devices and techniques have been used within textile finishing equipment such as tenter frames. While temperature measuring sensors may be placed within the equipment where the textile material undergoes drying and curing, such sensors are generally unable to accurately determine temperature on the fabric surface or in close proximity thereto. Further, because of the high air flow rates that are generally imparted within a tenter frame or other drying or curing equipment, temperature sensors that are in fixed position within the tenter frame are often unable to adequately reflect the temperature and drying effects being experienced by the textile material. Tenter frames are often relatively wide, and it is sometimes difficult for conventional sensing in one location to adequately predict the drying and curing effects on the textile material in a location transversely disposed relative to the temperature sensor. Other factors, such as ambient temperatures, solution temperatures, relative humidity, air flow restrictions and other variables can also result in changes in the heating and drying capabilities of equipment during finishing operations. Such variables, which may impact the finishing operations, may not be readily detected through conventional sensing mechanisms.

Attempts have been made to attach thermocouples or other sensors directly to textile materials during finishing operations. As can be appreciated, such attempts are generally unsuitable for a number of reasons. These include the fact that tenter frames are generally enclosed to maintain consistent temperature and air flow properties. Providing an opening within the tenter frame to measure temperature of the textile web by contacting the surface of the material will generally impact the temperature and air flow properties within the tenter frame resulting in an inaccurate reading. Attempts to attach a sensor to the textile material and allow it to pass through the tenter frame is often impractical due to the need for long electrical leads which would be necessary to obtain readings from the sensor as it passes through the longitudinal path within the tenter frame. Generally, long leads serve to conduct heat which results in inaccurate readings. The resistance and other properties of long leads makes such sensing potentially inaccurate. In addition, if this were to be done, the long leads associated with the sensor could potentially damage a large amount of fabric, such as coated fabric, requiring it to be scrapped. Therefore, such approaches are generally not suitable.

Thus, there exists a need for an improved system and method for monitoring temperatures in textile finishing operations. There further exists a need for an improved method of monitoring temperatures during textile finishing operations that is more accurate, can be performed more frequently and at more locations transversely across a moving textile web, and which results in the production of less scrap material.

### DISCLOSURE OF INVENTION

It is an object of an exemplary embodiment of the present invention to provide a temperature monitoring system for textile finishing operations.

It is a further object of an exemplary embodiment of the present invention to provide a temperature monitoring system for textile finishing operations that provides more accurate temperature measurement.

It is a further object of an exemplary embodiment of the present invention to provide a temperature monitoring system for textile finishing operations that can be used to determine temperatures of textile materials in numerous locations as material passes through a finishing operation.

It is a further object of an exemplary embodiment of the present invention to provide a temperature monitoring system for textile finishing operations that can be used to determine temperatures at a plurality of transverse locations on a moving textile web.

It is a further object of an exemplary embodiment of the present invention to provide a temperature monitoring system for textile finishing operations that can be used to measure temperatures more reliably both at a surface of the material, as well as at locations disposed from but in proximity to the material.

It is a further object of an exemplary embodiment of the present invention to provide a temperature monitoring system for textile finishing operations that is reliable, easy to use and that can be utilized without producing excessive scrap.

It is a further object of an exemplary embodiment of the present invention to provide methods for monitoring temperatures of textile materials in textile finishing operations.

Further objects of exemplary embodiments of the present invention will be made apparent in the following Best Modes For Carrying Out Invention and the appended claims.

The foregoing objects are accomplished in an exemplary embodiment through the use of a temperature sensing device which passes through a tenter frame with a moving web of textile material. The temperature sensing device is releasibly engageable with the moving web at a location ahead of where the fabric enters the tenter frame, and passes through the tenter frame with the moving web. In the exemplary embodiment, the temperature sensing device is operative to sense and record temperatures at a plurality of locations within the tenter frame. After the device has passed through the tenter frame, the device is disengaged from the moving web and the data analyzed.

In the exemplary embodiment, the temperature sensing device includes a positionable sensing member that extends from the body and enables a user to selectively sense temperature as desired, either at the surface of the web or in selected positions above the surface of the web. In addition, in the exemplary embodiment, the sensing device utilizes the temperature sensing member to sense temperature on the fabric ahead of the body of the device so as to minimize the effects of the device on the measurements. In addition, the exemplary embodiment has an aerodynamic shape so as to minimize the effects on the air flow due to the presence of the sensing device.

In the exemplary embodiment, data corresponding to temperature that is stored within the temperature sensing device is output to a computer after the device is disengaged from the web. The computer may be used to analyze the data and to provide visually perceivable outputs such as graphical outputs on a display or printed graphs that facilitate analysis of the temperature properties experienced by the textile material in the finishing operations. This enables an operator to adjust the conditions within the tenter frame as appropriate to maintain desirable properties. Further, in some alternative embodiments, data corresponding to temperature sensed by the device, can be manipulated by the computer and used to control the making of adjustments within the tenter frame.

In exemplary embodiments, the temperature sensing device includes an insulating body which houses a removable module. This may facilitate programming of the module with desired parameters related to data capture. It may also facilitate transferring the data from the temperature sensing device to a remote computer. In some alternative embodiments, wireless communication capability may be provided between the temperature sensing device and a remote computer so as to facilitate real time or near real time monitoring of temperature within the tenter frame.

In the exemplary embodiment, the temperature sensing device may be used repeatedly to capture temperature data at a plurality of locations relative to the moving web of textile material. This may include capturing data at the surface of the web, and thereafter capturing data related to temperature a selected distance above the web. This may be done in the exemplary embodiment by adjusting the sensing member. In addition, in the exemplary embodiment, data can be captured in a plurality of transversely disposed locations across the web. This may be done by attaching the temperature sensing device in different transverse locations relative to the web and passing it through the tenter frame. This enables reliably monitoring the drying and curing action imparted by the tenter frame in such various locations and helps to assure that the finishing process is uniform across the web. Additional advantages of exemplary embodiments will be apparent from the detailed description provided herein.

### DETAILED DESCRIPTION OF DRAWINGS

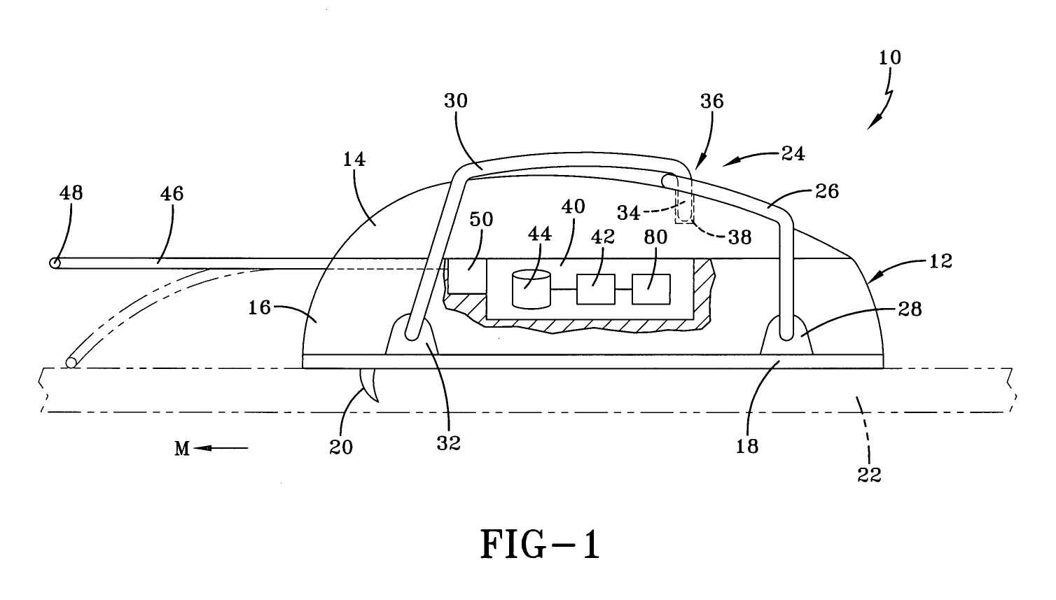

FIG. 1 is a side view of an exemplary temperature sensing device for sensing temperature in finishing operations of textile materials.

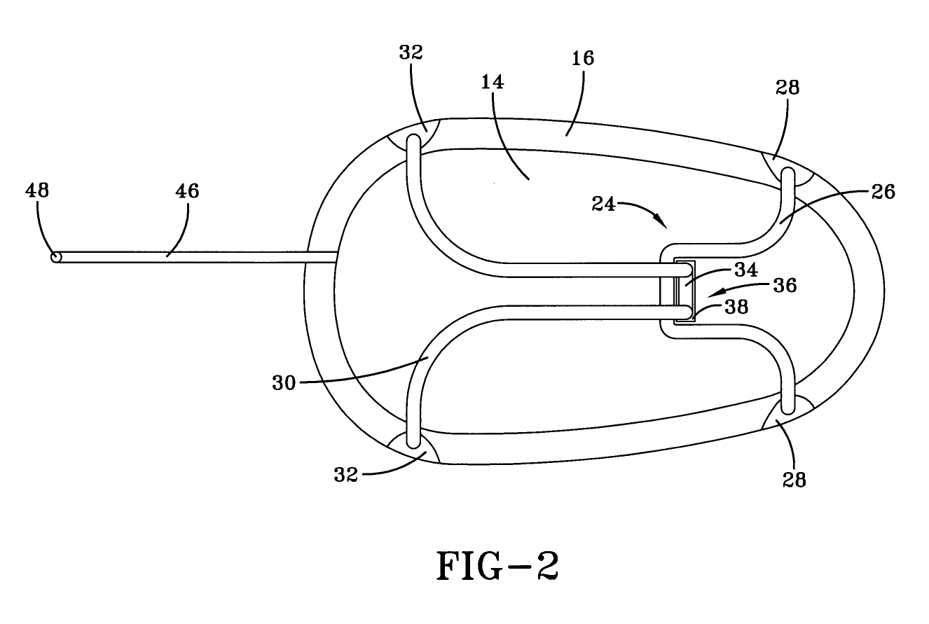

FIG. 2 is a top plan view of the device shown in FIG. 1.

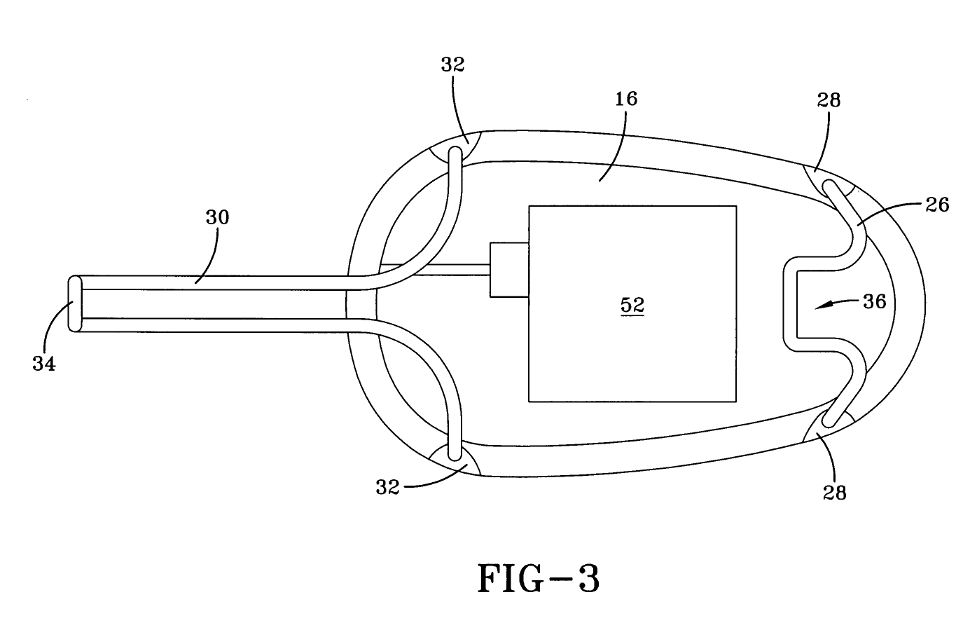

FIG. 3 is a top plan view of a device shown in FIG. 1 with the fastening mechanism open and the cover portion and internal data capture module removed.

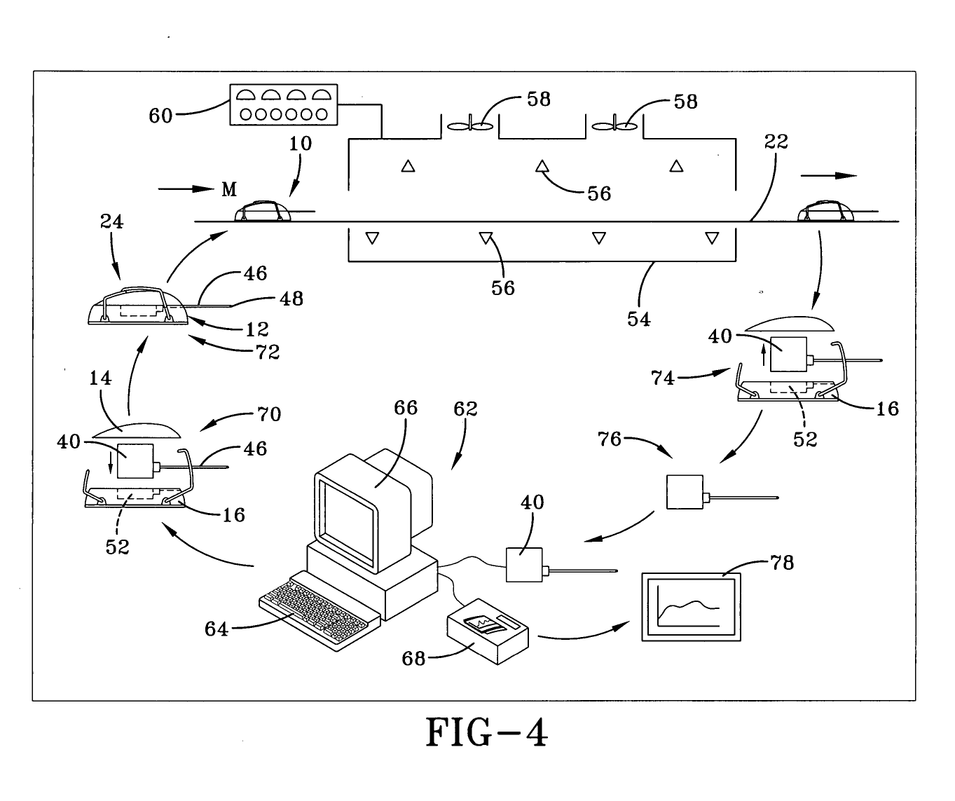

FIG. 4 is a schematic view which represents the use of the temperature sensing device and an exemplary method for using the device in monitoring temperatures in textile finishing operations.

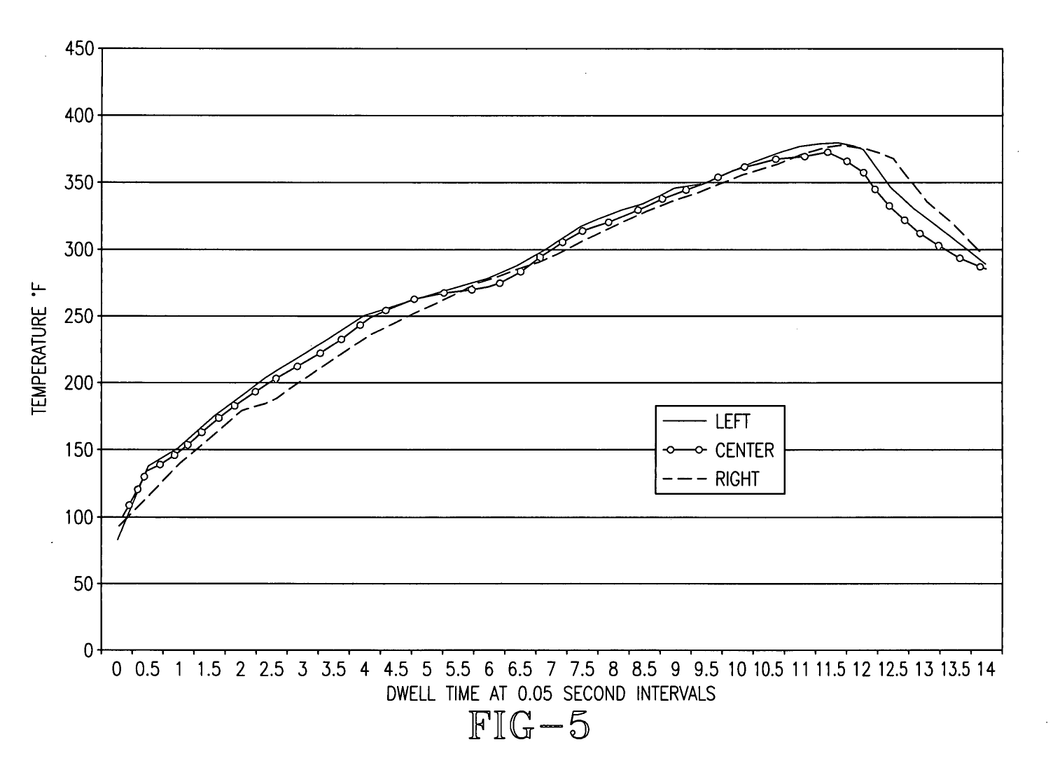

FIG. 5 is a graph showing sample results for temperature vs. time as the temperature sensing device passes through a tenter frame in various transverse locations across a textile web.

### BEST MODES FOR CARRYING OUT INVENTION

Referring now to the drawings and particularly to FIG. 1, there is shown therein an exemplary temperature sensing device generally indicated 10. Temperature sensing device 10 includes a body 12. Body 12 is comprised of temperature insulating material. Such material is used to limit the exposure of electronic components that are housed in the body to high temperatures which are encountered in the textile finishing operations in which the device is intended to be used. In the exemplary embodiment, the portions of the body in surrounding relation of electronic components are comprised of balsa wood. Further, the exterior of the body is coated with a light color epoxy paint so as to provide greater temperature resistance and to limit radiation absorption. Of course this approach is merely exemplary.

In the exemplary embodiment, body 12 comprises a cover portion 14 and a base portion 16. The cover portion and base portion are relatively movable to enable access to components within the interior thereof. In the exemplary embodiment, the cover portion and base portion are separable, but in other embodiments such portions may be hinged or otherwise made relatively movable without being entirely separable.

Base portion 16 includes a bottom plate 18. Bottom plate 18 is generally permanently attached to the insulating material which in operation is positioned above the plate. Bottom plate 18 of the exemplary embodiment has extending therefrom engaging members 20 only one of which is shown. Engaging members 20 comprise a plurality of pin members which extend outward from the bottom plate 18. The engaging members 20 are adapted to releasibly engage a moving web of textile material 22 shown in phantom. In the use of the temperature sensing device 10 as later described in detail, the engaging members 20 enable the device to be releasibly attached to a moving textile web and to maintain engagement therewith as the web passes through finishing operations. In the exemplary embodiment, the web moves in the direction of Arrow M shown in FIG. 1. As shown, the exemplary form of the pins 20 are such that they provide a hook-like engagement with the moving web. This configuration helps to assure that the temperature sensing device of the exemplary embodiment maintains engagement with the web and does not move relative thereto as it passes through the finishing operations. Of course this approach is exemplary, and in other embodiments, other approaches may be used.

The exemplary sensing device 10 includes a fastening mechanism 24 that is used to realeasibly hold the cover portion 14 to the base portion 16. Fastening mechanism 24 includes a first latch portion 26. First latch portion 26 has inward extending end portions that are rotatable in rear ear portions 28 of bottom plate 18. (See, FIG. 2). Fastening mechanism 24 further includes a second latch portion 30. Second latch portion 30 includes in-turned end portions that are rotatable in front ear portions 32 of bottom plate 18.

Second latch portion 30 includes a finger portion 34. Finger portion 34 is releasibly engageable through U-shaped opening 36 formed in the first latch portion. In the closed position of the fastening mechanism 24 shown in FIG. 2, the finger portion 34 extends through the opening and into a recess 38 in the cover portion 14. In this position, the fastening mechanism 24 is operative to hold the cover portion and the base portion of the temperature sensing device in engaged relation. In the exemplary embodiment, the configuration of the fastening mechanism is such that contact between the body and obstructions during use generally does not result in the fastening mechanism opening. This is because impacts with obstructions generally apply forces on latch portion 30 which tend to hold the latch portions in engagement.

In FIG. 3, the component first and second latch portions 26 and 30 of fastening mechanism 24 are shown in the disengaged position and can be released when desired so as to enable the cover portion to be moved relative to and/or detached from the base portion. This is done by moving the second latch portion such that the finger portion 34 no longer extends through U-shaped opening 36 of the first latch portion 26 and is disengaged from recess 38 in the cover portion 14. It should be understood that this approach is exemplary and in other embodiments other approaches may be used.

Returning to the discussion of the exemplary embodiment shown in FIG. 1, the body 12 during operation encloses in insulating relation an electronic module 40. Module 40 of the exemplary embodiment includes at least one computer processor schematically indicated 42. The processor 42 is in operative connection with at least one data store 44. In the exemplary embodiment, the processor 42 is programmably operable responsive to data capture parameters. These parameters in exemplary embodiments may include parameters such as current time, start time and sample rates. Of course these parameters are exemplary, and in other embodiments, other or additional parameters may be used.

In the exemplary embodiment, the data store 44 may include RAM or other processor accessible storage. The data store is operative to hold program parameters and other instructions that are executed by the processor. Further, in the exemplary embodiment, the data store is operative to store data corresponding to temperatures sensed at a plurality of locations as the temperature sensing device 10 moves through the textile finishing operations. The data stored in the exemplary embodiment includes data corresponding to temperature readings that are made at periodic intervals in accordance with program parameters as the device travels in connection with the web of textile materials through the tenter frame. In the exemplary embodiment, the module 40 includes a data logger device, and specifically an HOBO Model H12-002 produced by MicroDAQ.com. Of course, in other embodiments, other types of processors, data stores and suitable circuitry may be used.

In the exemplary embodiment shown in FIG. 1, module 40 is in operative connection with a sensing member 46. Sensing member 46 is positionable relative to body 12 so as to facilitate temperature sensing in a desired location. In the exemplary embodiment, sensing member 46 includes a thermocouple 48 at a distal end thereof. Sensing member 46 is comprised of sufficiently flexible yet rigid material so that the thermocouple may be moved to a position relative to the web 22 and will maintain the relative position as the device passes through the tenter frame. For example, as represented in phantom, sensing member 46 may be positioned relative to the body such that the thermocouple 48 is positioned at the surface of the web. This may be desirable in some situations as it provides an accurate reading of temperature directly at the surface of the material. Alternatively, the sensing member 46 may be positioned relative to the body 12, so that the thermocouple 48 is operative to sense temperature a selected distance above the web. This may be desirable, for example, in cases where the temperature in an area where water and other vapors are being liberated from the textile material is of critical importance. Of course various approaches may be used depending on the desires of the operator of the system.

In the exemplary embodiment, sensing member 46 is comprised of a bendable wire material and the thermocouple is a K type thermocouple. Of course these approaches are exemplary, and in other embodiments, other types of sensing devices and sensing members may be used.

As shown in FIGS. 1 through 3, in the exemplary embodiment, the sensing member 46 extends outside of the body 12 during operation. The thermocouple is electrically connected to the processor 42 in the module 40 through a releasible connector 50. The releasible connector 50 enables the sensing member of the thermocouple to be disconnected from the module. This may facilitate transporting the module for connection to a computer as later described. In addition, the ability to readily separate the thermocouple from the module enables testing of the thermocouple as well as readily replacing the thermocouple in the event of damage. Of course this approach is exemplary, and in other embodiments, other approaches may be used.

As shown in FIG. 3, when the cover portion 14 is separated from the base portion 16, the module 40, the connector 50 and a portion of the sensing member 46 which normally extend within the body 12 during operation, are exposed. Further, in the exemplary embodiment the module, releasible connector and sensing member are enabled to be removable from within the body. To facilitate such removal the interior of the body includes a formed pocket 52 that is sized to accept the module and attached components therein. Pocket 52 is sized however such that the module, connector and sensing member may be readily removed therefrom when the cover is open. This facilitates transferring the data from the module to a computer in some embodiments. It also enables the ready replacement of modules within the body in the event of damage or malfunction. Of course this structure is exemplary.

As shown in FIG. 1, during operation of the exemplary embodiment the sensing member is positioned relative to the moving web 22 such that the thermocouple 48 senses temperature ahead of the body 12 of the device. This facilitates accurate measurement as the body does not tend to interfere with the temperature of the web in the area where the temperature is sensed. In addition, it should be noted that in the exemplary embodiment, the body 12 has an aerodynamic shape that poses limited resistance to air movement. This minimizes the risk that the high air flows that are often encountered in drying and curing operations will cause the body to separate from the web or move relative thereto. Thus, the pins 20, which are the engaging members of the exemplary embodiment, enable the body to be maintained in engagement with the web despite the impingement of hot, high velocity air on the device. In addition, in the exemplary embodiment, the maintenance of the relative position of the body and the web helps to achieve more reliable temperature sensing by assuring that the thermocouple is positioned relative to the web at the desired location. Of course these approaches are exemplary, and in other embodiments, other approaches may be used.

The exemplary method for use of temperature sensing device 10 is represented in FIG. 4. In the exemplary method, the device 10 is used to monitor temperature within a tenter frame 54 through which the web 22 of textile material continuously moves and undergoes finishing operations. In the exemplary method, the tenter frame 54 is operative to provide drying and curing action to the web of textile material. Although a tenter frame is described as used in connection with the exemplary embodiment, it should be understood that other embodiments may include other types of drying and/or curing devices which may be used in connection with the curing and drying of finishes and coatings on textiles or other materials.

As schematically represented, tenter frame 54 includes a plurality of heating devices 56. Heating devices 56 are operative to selectively heat a plurality of areas or zones within the tenter frame. In the tenter frame, controlled air flow is provided through air moving devices schematically represented 58. Of course, it should be understood that tenter frames or other devices may include various types of heating devices, air movement devices, stretching devices or other suitable devices for purposes of mechanically acting on the material as well as chemically reacting the finishing chemicals. The heating devices 56, and air moving devices 58 are controlled by one or more controllers schematically indicated 60. Controllers 60 may be suitable computers or other types of controllers that are operative to enable selectively changing the output of heating devices included within areas of the tenter frame. The controller 60 may also be operative to control other parameters such as air flow within the various areas of the tenter frame.

In the use of device 10 as shown in FIG. 4, the module 40 is initially separated from base portion 16 of the body 12 and operatively engaged with the computer 62. Computer 62 may be various types of desktop, laptop or other computing devices that are suitable for purposes of programming one or more parameters within the module 40. Computer 62 of the exemplary embodiment includes an input device in the form of a keyboard 64, and output devices which include a display 66 and a printer 68. Of course, in other embodiments, other types of input and output device may be used.

In the exemplary method of operation, the computer 62 is a personal computer which operates using a Microsoft® Windows® XP Professional operating system and a Microsoft® Excel spreadsheet program. In addition, the computer has operating therein software for programming and recovering data from the module. In the exemplary embodiment, Boxcar Pro 4.0 software is operated in the computer. Of course these items may be different in other systems.

Initially, in executing the exemplary method, the module 40 is operatively engaged with the computer 62. This is done through connection of the module with the computer through a serial connector on the module and a suitable cable. The computer operates to recognize the module and to communicate therewith. The computer program operating in the module also operates to cause the module to be programmed with data capture parameters. These parameters include in the exemplary embodiment the current time which is based on the time clock as set in the computer 62. Program parameters also include a start time at which the module will begin capturing data, as well as data corresponding to a sample rate at which the module processor will operate to capture and store in its data store, temperature readings once the start time has been reached. In the exemplary embodiment, a sample rate of one-half second intervals is used. Of course this approach is exemplary. Also, in the exemplary embodiment, the start time is generally set at a time after the then current time so as to enable the operator to have the module installed in the body and the body placed on the web at the incoming side of the tenter frame. In alternative embodiments, modules may be provided with actuators which may be manually or remotely triggered to cause the module to begin capturing temperature data.

Once the exemplary module 40 has been programmed, it is positioned with the sensing member 46 attached thereto within base portion 16 of the body 12. This is initially done by placing the module 40 in the pocket 52 of the base portion 16. This is represented by partially assembled device 70 in FIG. 4.

In the exemplary embodiment, once the start time is reached, the module 40 has a flashing indicator that begins flashing to indicate that temperature data is now being recorded. Once the operator observes that the start time programmed has been reached, the user of the device installs the cover portion 14 on the body and secures the fastening mechanism 24. Of course, in other embodiments, the operator may take other steps to trigger an actuator to commence data capture. Thereafter, the user may adjust the sensing member 46 so that the thermocouple 48 is sensing temperature in the desired position relative to the surface of the web. This is represented by the assembled device 72 in FIG. 4.

With the module enclosed within the insulating body and the sensing member properly positioned, the temperature sensing device 10 is engaged with the moving web 22 on the incoming side of the tenter frame 54. As represented in FIG. 4, the temperature sensing device 10 moves in the direction of Arrow M in engagement with the web through the tenter frame 54. As this occurs, the module 40 responsive to operation of the processor records data corresponding to the temperatures sensed at a plurality of locations within the tenter frame. This plurality of locations corresponds to the location of the temperature sensing device at each of the half-second intervals at which temperatures are sensed in accordance with the programmed parameters.

Once the temperature sensing device 10 has passed through the tenter frame, the device 10 is releasibly engaged from the web. At this point, the data that has been captured may be analyzed. Alternatively, the device may be again passed through the tenter frame so as to capture additional data. In some exemplary methods, the device may be passed through the tenter frame multiple times at various distances from the transverse edges that bound the web. Alternatively, or in addition, the device 10 may have its sensing member repositioned so as to take additional readings at a different location relative to the upper surface of the web. By making additional runs through the tenter frame, additional data is captured which can be analyzed and compared to data corresponding to suitable ranges to achieve the necessary drying and curing of the particular textile material being produced.

In the exemplary embodiment when additional data is to be captured, the temperature sensing device 10 may be disengaged from the web at the outgoing end of the tenter frame and returned to the incoming end. At the incoming end, the temperature sensing device may be moved to a different transverse position relative to an edge of the web or otherwise relocated with regard to the temperature sensing thermocouple so as to gather additional data desired for purposes of analysis.

After the desired number of passes through the tenter frame, the device may be disengaged from the web, the fastening mechanism released and the body opened. This is represented by the open body 74 shown in FIG. 4. The module 40 may then be removed from the pocket 52 and transported so as to again be operatively connected with the computer. This is represented in FIG. 4 by the separated module 76. The module 40 is then again placed in operative connection with the computer 62, and the computer is operative to cause the data stored in the data store of the module to be transmitted to the computer.

The computer upon receiving the data from the module may be operative to analyze the data in accordance with inputs provided by the operator. These inputs may include separating the data for each run that is made through the tenter frame. Such data may be readily separated in the exemplary embodiment based on time as recorded for the various runs as well as the temperature profiles. It will generally be apparent from the stored data when the temperature sensing device enters into proximity with the heating devices within the tenter frame as well as when the temperature sensing device passes out of the tenter frame. The computer in exemplary embodiments may be operative to include the data in a spreadsheet program, such as Microsoft® Excel, and to produce graphs of the temperature profiles which are visually perceivable. Such perceivable outputs may include outputs through the screen 66 or graphs produced by the printer 68. Such a graph is schematically represented 78 in FIG. 4, and is also shown in more detail in FIG. 5.

The graph in FIG. 5 represents the data gathered in three passes of the temperature sensing device through the tenter frame. Each of the lines in the graph represents a different pass. In this exemplary data, three passes were made through the tenter frame. One pass was made adjacent to the left side transverse edge of the web. Another pass was made with the temperature sensing device adjacent to the right side transverse edge of the web, and a separate pass was made with the temperature sensing device at the center of the web. This graph shows differences in the various heating zones across the web. The data may be analyzed by the machine operator so as to make adjustments in the heating devices within the areas of the tenter frame. Such adjustments may include adjustments related to the output of heating devices in various areas of the tenter frame and adjustment of air flows so as to achieve the desired temperatures. Of course these approaches are exemplary, and in other embodiments, other approaches may be used.

Alternatively, computer 62 may be operatively connected to controller 60, so as to provide communication therewith and to enable adjustment of the heating devices and other devices within the tenter frame in response to the data captured. This may be done for example by a program operating in the computer 62 comparing the data received from the temperature sensing device to set parameters or ranges. The computer 62 may calculate the need for any adjustments based on the data received. The computer may communicate through a local network to the controller 60, and the controller may operate to adjust the appropriate devices within the tenter frame. Of course this approach is exemplary, and in other embodiments, other approaches may be used.

Although, in the exemplary embodiment, temperature data is captured by the module 40 and then later passed to the computer for analysis, in alternative, embodiments real time or near real time data capture may be achieved. This may be done for example by including a wireless communication device schematically indicated at 80 within the body 10 as shown in FIG. 1. Such a wireless device may include, for example, an RF transmitter such as a Bluetooth device, or other suitable communication device that may be operative to communicate temperature data to one or more remote computers. Such a wireless communication device may be used for example to transmit temperature data on a real time basis to a computer or other device outside the tenter frame as the temperature sensing device is passing therethrough. Further, in other alternative embodiments, the temperature sensing device may pass through the tenter frame and may wirelessly communicate its data to a computer or other device after having passed therethrough. This may be useful in some embodiments by avoiding the need to install and separate a module or other data storage device from the body. Of course these approaches are exemplary, and in other embodiments, other approaches may be used.

As can be appreciated, the exemplary embodiments described are used in providing more accurate temperature data in textile finishing operations. Such approaches may also be used to achieve more accurate measurements without producing unsuitable amounts of scrap material. This may enable more frequent testing and more precise control which results in improved product quality. Further, although the exemplary embodiment is described as used in connection with textile finishing operations, such approaches may also be applied to other comparable processes.

Thus, the textile finishing temperature monitoring systems and methods of the exemplary embodiments achieve one or more of the above-stated objectives, eliminate difficulties encountered in the use of prior devices and systems, solve problems and attain the desirable results described herein.

In the foregoing description, certain terms have been used for brevity, clarity and understanding, however no unnecessary limitations are to be implied therefrom because such terms are for descriptive purposes and are intended to be broadly construed. Moreover, the descriptions and illustrations herein are by way of examples, and the invention is not limited to the details shown and described.

In the following claims, any feature described as a means for performing a function shall be construed as encompassing any means known to those skilled in the art to be capable of performing the recited function, and shall not be deemed limited to the structures shown in the foregoing description or mere equivalents thereof.

Having described the features, discoveries and principles of the invention, the manner in which it is constructed and operated, and the advantages and useful results attained; the new and useful structures, devices, elements, arrangements, parts, combinations, systems, equipment, operations, methods, processes and relationships are set forth in the appended claims.

1. A method comprising:
a. releasibly attaching a temperature sensing device to a web of textile material;
b. moving the web with the temperature sensing device attached thereto, adjacent to a heater device;
c. recording data corresponding to temperature sensed by the temperature sensing device at a plurality of locations adjacent the heater device as the temperature sensing device moves in engagement with the web;
d. disengaging the temperature sensing device from the web after the sensing device has passed the heater device.

2. The method according to claim 1 wherein (c) includes recording data corresponding to temperature in at least one data store in the temperature sensing device, and subsequent to (d),
e. transferring data stored in the data store to a computer.

3. The method according to claim 1 wherein the web is moved through a tenter frame, and wherein in (b) the tenter frame includes the heater device.

4. The method according to claim 1 and prior to (a) further comprising:
e. positioning a sensing member operatively connected to the temperature sensing device relative to a surface of the web, wherein temperature is sensed on the sensing member.

5. The method according to claim 4 wherein in (e) the sensing member is positioned to sense temperature at the surface of the web.

6. The method according to claim 4 wherein in (e) the sensing member is positioned to sense temperature in air above the surface of the web.

7. The method according to claim 4 wherein the temperature sensing device comprises a body, and wherein the sensing member extends from the body, and wherein (e) comprises moving the sensing member relative to the body.

8. The method according to claim 7 wherein the sensing member includes a thermocouple, and wherein (e) includes positioning the thermocouple relative to the web and ahead of the body relative to the moving web.

9. The method according to claim 1 wherein the temperature sensing device comprises a body of temperature insulating material, and further comprises a module including at least one processor, and prior to (a),
e. positioning the module within the body.

10. The method according to claim 9 wherein the module includes at least one data store and wherein in (c) the data corresponding to temperature sensed is recorded in the at least one data store.

11. The method according to claim 10 and further comprising:
f. outputting the data corresponding to temperatures stored in the at least one data store, to a computer separate from the temperature sensing device.

12. The method according to claim 11 and subsequent to (d):
g. removing the module from within the body, and
h. operatively connecting the module with the computer, wherein in (f) the data is output to the computer through such operative connection.

13. The method according to claim 12 wherein the body includes a pocket, and wherein in (e) the module is positioned in the pocket, and wherein in (g) the module is removed from the pocket.

14. The method according to claim 13 wherein the body includes a separable base portion and cover portion held in releasible engagement by a fastening mechanism, and further comprising:
prior to (e) separating the cover portion and the base portion, whereby the pocket is accessible, and
subsequent to (e) and prior to (a) engaging the cover portion in engaged relation with the base portion through action of the fastening mechanism.

15. The method according to claim 14 and subsequent to (d) and prior to (g) releasing the fastening mechanism and separating the cover portion and the base portion, whereby the pocket is accessible and the module is enabled to be removed from the pocket.

16. The method according to claim 9 wherein the module includes at least one member extending therefrom, and wherein subsequent to (e) the member extends outside the body.

17. The method according to claim 1 wherein the temperature sensing device includes a body, and wherein the body is in operative connection with at least one web engaging member, and wherein (a) includes engaging the at least one engaging member and the web.

18. The method according to claim 17 wherein the at least one engaging member comprises a plurality of pins, and wherein (a) includes engaging the pins and the web, and wherein (d) includes disengaging the pins and the web.

19. The method according to claim 1 wherein in (a) the temperature sensing device is engaged in a first transverse location relative to the web, and subsequent to (d), repeating (a) through (d) with the temperature sensing device engaged with the web in a second transverse location disposed of the first transverse location.

20. The method according to claim 19 wherein the web includes a first transverse edge, and wherein the second location is disposed further from the first transverse edge than the second location.

21. The method according to claim 3 and further comprising at least one controller in operative connection with the tenter frame, and wherein the at least one controller is operative to control at least one of temperature and air flow in the tenter frame, and further comprising:
e. adjusting at least one of temperature and air flow in the tenter frame through operation of the at least one controller responsive to the data recorded in (c).

22. The method according to claim 21 and subsequent to (e) repeating (a) through (d).

23. The method according to claim 22 and further comprising repeating (e) responsive to the data recorded in repeated (c).

24. The method according to claim 1 and further comprising:
e. communicating data corresponding to temperature from the temperature sensing device to a computer separate from the device.

25. The method according to claim 24 wherein (e) is performed subsequent to (d).

26. The method according to claim 24 wherein in (e) the data is communicated wirelessly.

27. The method according to claim 26 wherein (e) is executed during at least a portion of (b).

28. The method according to claim 1 and prior to (a) further comprising:
e. operatively engaging at least one processor that is within the device during (b), with a computer; and
f. programming the at least one processor with at least one parameter relative to recording data in (c).

29. The method according to claim 28 wherein in (f) the at least one parameter corresponds to at least one of current time, start time and sampling rate.

30. The method according to claim 28 wherein the temperature sensing device comprises a body and a module separable from the body, wherein the module includes the at least one processor, and wherein in (f) the module is programmed while the module is separated from the body, and subsequent to (f) and prior to (a) engaging the module and the body.

31. The method according to claim 30 wherein the module includes at least one data store, wherein in (c) data is recorded in the at least one data store of the module, and subsequent to (b),
g. separating the module from the body,
h. subsequent to (g) operatively connecting the module and the computer, and
i. during at least a portion of (h), transferring data recorded in (c) from the data store to the computer.

32. The method according to claim 31 and subsequent to (i), producing at least one visually perceptible output corresponding to data recorded in (c), through at least one output device operatively connected with the computer.

33. The method according to claim 1 and further comprising:
e. outputting through at least one output device, at least one visually perceptible output corresponding to data recorded in (c).

34. A method comprising:
a. operatively engaging a temperature recording module including a processor and a data store, and a computer;
b. during at least a portion of (a), programming the processor of the module through operation of the computer with at least one temperature sampling parameter, the at least one sampling parameter including at least one of a current time, a start time and a sample rate;
c. subsequent to (b) operatively disconnecting the module and the computer;
d. subsequent to (c) placing the module within a device including an insulating body, wherein the insulating body is in operative connection with a plurality of pins adapted to engage a web of textile material;
e. subsequent to (d), positioning relative to the body a movable sensing member that extends outward from the body and which includes a thermocouple in operative connection with the module;
f. subsequent to (d) engaging the body through the plurality of pins with a moving web of textile material;
g. subsequent to (f), moving the body in engagement with the web through a tenter frame that includes a heater device;
h storing in the data store in the module during at least a portion of (g), data corresponding to temperature sensed by the thermocouple;
i. disengaging the body from the device after the body has passed through the tenter frame;
j. subsequent to (i), repeating (f) through (i) at least once;
k. subsequent to execution of (i) at least once, separating the module from the body;
l. subsequent to (k), engaging the module and the computer;
m. during at least a portion of (l), transferring data from the data store in the module to the computer;
n. subsequent to commencing (m), producing at least one visually perceivable output through at least one output device operatively connected to the computer, wherein the at least one visually perceivable output corresponds to at least a portion of the data transmitted from the data store in the module;
o. subsequent to (n) adjusting at least one of air flow and temperature in at least one area in the tenter frame responsive to the at least one visually perceivable output.

35. Apparatus comprising:
a body comprised of temperature insulating material;
at least one engaging member in operative connection with the body, wherein the at least one engaging member is adapted to releasibly engage textile material such that the body moves therewith;
a processor positioned within the body;
a sensing member in supporting connection with the body and in operative connection with the processor;
wherein the processor is operative to cause to be recorded, data corresponding to temperature on the sensing member as the body moves in engagement with textile material.

36. The apparatus according to claim 35 wherein the sensing member extends outward relative to the body and is movably positionable relative to the body as well as textile material to which the body is engaged.

37. The apparatus according to claim 36 wherein the sensing member includes a thermocouple.

38. The apparatus according to claim 36 and further comprising a data store within the body, wherein data corresponding to temperature is stored in the data store.

39. The apparatus according to claim 36 and further comprising a wireless communication device within the body and in operative connection with the processor.

40. The apparatus according to claim 38 and further comprising a module, wherein the module includes the processor and data store, and wherein the module is releasibly engageable with the body.

41. The apparatus according to claim 40 wherein the body comprises a pocket therein, and a relatively movable cover portion and base portion, wherein the pocket is enabled to be accessed when the cover portion is moved relative to the base portion, and wherein the module is removably positionable within the pocket.

42. The apparatus according to claim 41 wherein the cover portion and base portion are separable, and further comprising a fastening mechanism, wherein the fastening mechanism is operative in a first condition to hold the cover portion and base portion in engaged relation, and in a second condition to enable the cover portion and base portion to be separated.

43. The apparatus according to claim 40 wherein the processor is programmable to operate in accordance with at least one temperature data capture parameter.

44. The apparatus according to claim 43 wherein the at last one data capture parameter corresponds to at least one of a current time, a start time and a sampling rate.

45. The apparatus according to claim 44 and further comprising at least one computer, wherein the computer is operatively connectable with the module, and wherein the computer is operative to cause the module to be programmed with the at least one data capture parameter.

46. The apparatus according to claim 45 wherein the computer receives data corresponding to temperature stored in the data store of the module.

47. The apparatus according to claim 46 and further comprising at least one output device in operative connection with the computer, wherein the computer is operative to cause at least one visually perceivable output corresponding to the data corresponding to temperature to be output through the at least one output device.

48. The apparatus according to claim 47 wherein the at least one output device comprises at least one of a display and a printer.

49. The apparatus according to claim 48 and further comprising:
a moving web textile material;
a heater device, wherein the moving web moves adjacent to the heater device, wherein the body moves in engagement with the web adjacent to the heater device and the data store records data corresponding to temperature as the body moves adjacent the heater device.

50. The apparatus according to claim 49 wherein the processor is operative to cause data to be stored in the data store corresponding to temperature in a plurality of locations adjacent to the heater device.

51. The apparatus according to claim 50 and further comprising a tenter frame, wherein the tenter frame includes the heater device, whereby data corresponding to temperature is recorded in a plurality of locations as the web moves through the tenter frame.

52. The apparatus according to claim 51 and further comprising at least one controller in operative connection with the tenter frame, wherein the at least one controller is operative to control at least one of temperature and air flow in at least one area of the tenter frame.

53. The apparatus according to claim 52 wherein the at least one controller is in operative connection with the computer, and wherein at least one of temperature and air flow in the tenter frame is adjusted responsive to data corresponding to temperature stored in the data store of the module.

54. The apparatus according to claim 49 wherein the sensing member is movably positionable relative to a surface of the web.

55. The apparatus according to claim 49 wherein the at least one engaging member comprises a plurality of pins engageable with the web.
